(19) United States
(12) Patent Application Publication
(10) Pub. No.: US 2009/0146581 A1
(43) Pub. Date: Jun. 11, 2009

(54) GAS DISCHARGE LAMP DRIVER CIRCUIT WITH LAMP SELECTION PART

(75) Inventors: Henri Arnoud Ignatius Melai, Eindhoven (NL); Arnold Willem Buij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/719,862

(22) PCT Filed: Nov. 21, 2005
(86) PCT No.: PCT/IB2005/053832

§ 371 Date: May 22, 2007

(30) Foreign Application Priority Data
Nov. 26, 2004 (EP) 04106109.4

(51) Int. Cl. H05B 37/02

(52) U.S. Cl. 315/294

(57) ABSTRACT

A gas discharge lamp driver circuit, comprising an inverter (10) of a bridge type, which has first and second input terminals connected to DC power lines (6, 8) for receiving a DC power voltage and output terminals (18) for providing a substantial rectangular power voltage, a ballast (20), which is connected to the output terminals of the inverter and to one or more lamp circuits (30), each having a gas discharge lamp (32) connected in series with a current control circuit having a high frequency semiconductor switch element (34), which receives an individual selection signal (S1, S2) from a selection circuit (36), such that an individual lamp (32) can be selected to operate. If deselected, the switch element conducts such that current is diverted to a selected switch element to thereby only ignite and operate a lamp connected to a selected switch element.

### FIELD OF THE INVENTION

The invention relates to a gas discharge lamp driver circuit as described in the preamble of claim 1.

### BACKGROUND OF THE INVENTION

US 2004/0090190 A1 discloses a multiple lamp driver circuit by which a specific lamp can be selected to have the lamp operate and making other lamps inoperative. The document discloses examples for use with different lamps, amongst which lamps requiring a ballast. A common translucent bulb may contain several lamps with the ballast being arranged outside the bulb in a socket in which the bulb can be inserted. A single ballast is used for the lamps contained in the bulb. In series with each lamp and at the outside of the bulb there is connected an individual electronic switch, in particular a triac, of which a control terminal is supplied with an individual selection signal from a selection circuit to selectively turn the switches on or off. The AC power voltage supplied to the lamps is the mains voltage.

The triacs of the prior art circuit need to be re-ignited after each zero-crossing of the AC voltage. Choking coils may be necessary to meet today's RIF requirements, which makes the circuit bulky and which increases costs. Further, triacs change from a conducting to a non-conducting state only if a current through it lasts a sufficient time. Therefore triacs can not be used with high frequency applications, for example above 10 kHz.

### OBJECT OF THE INVENTION

It is an object of the invention to solve the drawbacks of the prior art circuit as described above.

### SUMMARY OF THE INVENTION

The above object of the invention is achieved by providing a gas discharge lamp driver circuit as described in claim 1.

Upon selection of the switch element of one lamp circuit and deselecting the switch elements of other lamp circuits, the selected switch element may conduct in both directions. A deselected switch element will still conduct a current in one of said directions through a junction of a drain region and the bulk of the switch element, such that the current in said one direction will be attenuated with respect to a current with the switch element being selected. As a result, current is diverted from a lamp circuit with a deselected switch element to the lamp circuit with a selected switch element, so that a lamp connected to a deselected switch element is prevented from being ignited.

### BRIEF DESCRIPTION OF THE DRAWINGS

The invention will become more gradually apparent from the following exemplary description in connection with the accompanying drawing. In the drawing:

FIG. 1 shows a diagram of a first embodiment of the circuit according to the invention; and

FIG. 2 shows a diagram of a second embodiment of the circuit according to the invention.

### DETAILED DESCRIPTION OF EXAMPLES

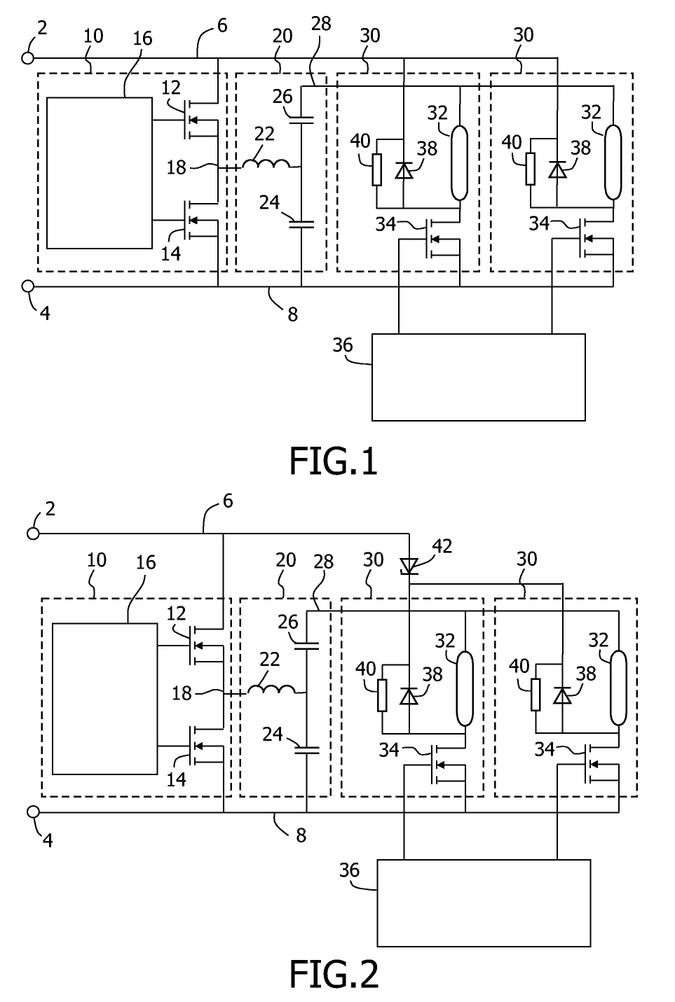

The diagram of the gas discharge lamp driver circuit of a first embodiment according to the invention shown in FIG. 1 comprises a first DC (direct current) voltage power input terminal 2, a second DC power input terminal 4, a first DC power line 6 and a second DC power line 8. DC terminals 2 and 4 are to be connected to a DC voltage power source (not shown). The DC voltage power source can be a rectifier circuit which rectifies an AC (alternating current) mains voltage.

An inverter circuit 10 is connected to the DC lines 6 and 8. The inverter circuit 10 comprises a first electronic switch 12, a second electronic switch 14 and a control circuit 16. As shown, switches 12 and 14 can be field effect transistors. Switches 12 and 14 are connected in series to the DC lines 6 and 8. Control inputs (gates) of switches 12 and 14 are connected to control outputs C1 and C2 of control circuit 16 respectively. Control circuit 16 operates to alternately turn switches 12 and 14 on and off, such that a substantial rectangular voltage is generated and supplied to a common node 18 of the switches. Said node 18 is also an output of the inverter 10. The frequency of the substantial rectangular voltage may be, for example, between 10 to 200 kHz.

An input terminal of a ballast circuit 20 is connected to the output 18 of the inverter 10. The input terminal of the ballast circuit 20 is connected to a first terminal of an inductor 22. By a capacitor 24 a second terminal of said inductor 22 is connected to a DC line (DC line 8 in FIG. 1). By a further capacitor 26 the second terminal of said inductor 22 is connected to a high frequency voltage supply line 28.

One or more lamp circuits 30 are connected to the high frequency voltage supply line 28 and a first DC line (DC line 8 in FIG. 1).

Each lamp circuit 30 comprises a lamp 32 and a semiconductor switch 34, which is in particular a field effect transistor with an isolated gate (IGFET), as shown. The lamp 32 and the semiconductor switch 34 are connected in series. A control input of the semiconductor switch 34 is connected to a control output of a selection circuit 36. Control inputs of semiconductor switches 34 of different lamp circuits 30 are connected to different control outputs S1, S2, and so on, of the selection circuit 36.

For simplicity of the description and the drawing, heating filaments of the lamps 34 and heating circuits connected to said filaments are omitted, if at all needed under the circumstances.

The selection circuit is operated to select one of the semiconductor switches 34 and to deselect the other semiconductor switches 34. If a semiconductor switch 34 is selected, a conducting channel between a drain and a source is established. Said channel will conduct a current in both directions. If a semiconductor switch 34 is deselected it will not establish a conducting channel.

If semiconductor switch 34 would be a perfect on/off switch it would not conduct when it is deselected. However, while during one half of the cycle of the high frequency voltage at supply line 28 the switch 34 is not conducting, during the other half of said cycle a current may still flow via a junction between a drain region (of a drain connected to a lamp 32) and the bulk semiconductor material of the switch 34 to said first DC line (DC line 8 in FIG. 1). The current during said second half of the cycle through a deselected switch 34 is smaller than through a channel of a selected switch 34. Therefore during both halves of the cycles current is diverted from deselected switches 34 to a selected switch 34. Then, the selected switch 34 is in a condition that a lamp 32 connected therewith can ignite. After ignition of the lamp 32 it will continue to operate with a reduced voltage across it and with further reduced currents through said junction of deselected switches 34.

In case a semiconductor switch 32 is deselected and it conducts a current via said junction at its drain, an inherent drain-source capacitance will be charged. An amplitude of an AC voltage across the switch 34 can easily become five times the DC voltage across DC lines 6 and 8. To protect the switch 32 against being damaged by an over-voltage its drain is connected to the other, second DC line (DC line 6 in FIG. 1) via a diode 38, such that a conductivity type of a semiconductor region of the diode 38, which is connected to the drain of said switch 34, is identical to a conductivity type of the drain region. Thus, during a certain half cycle of the high frequency voltage at supply line 28 current is diverted from the first DC line to said second DC line (from DC line 8 to DC line 6 in FIG. 1). Therefore, the voltage built up by the charging of the drain capacitance of switch 34 will be limited to DC voltage. The current diverted that way will still be sufficient to force all current provided through the ballast circuit 20 to flow through the selected lamp circuit 30 only.

Each lamp circuit 30 further comprises a resistor 40 which is connected to the drain of the switch 34 and said second DC line (DC line 6 in FIG. 1). If resistor 40 is connected with DC line 6 of a positive voltage, in a deselected state of the switch 34, the resistor 40 will pull up the DC voltage level at said drain. This will keep the drain-source capacitance to a minimum. It will avoid the unwanted flowing of an AC current, though small, through the lamp 32 of a deselected lamp circuit 30.

The diagram of the gas discharge lamp driver circuit of a second embodiment according to the invention shown in FIG. 2 differs from the first embodiment shown in FIG. 1 in that a lamp circuit 30 comprises in addition a zener diode 42, which is connected in series with the diode 38 and a resistor, such as resistor 40. In particular, as shown, a single zener diode 42 is used which is common to several lamp circuits 30. The use of zener diode 42 allows to take advantage of switches 34 which have higher break-trough voltages than the DC voltage across lines 6 and 8. For example, with said DC voltage being 200V, a break-trough voltage of switch element 34 of 600V, a zener diode 42 with a break-trough voltage of 400V can be used to allow the drain capacitance of switch 34 to be charged to 600V. Such a high voltage will allow faster switching of the lamp circuits 30 because of the higher AC voltage blocking capability.

It is observed that instead of an IGFET 34 other high frequency unidirectional switch elements can be used. For example, a bipolar transistor having an insulated gate (IGBT) and a bipolar transistor (BT) having a diode connected anti-parallel to a collector and an emitter thereof.

The gas discharge lamp driver circuit according to the invention was tested within an LCD device of a scanning type. In such a system several gas discharge lamps 32, which are used for back lighting, of the device are turned on and off alternately, for example with a frequency of 75 Hz and an on time of 2 ms. It was measured that during the off state of a lamp 32 it conducted a current of less than 1% of the current it conducted in its on state. This is a great improvement with respect to prior art LCD devices of the scanning type in which each lamp had its own inverter and its own ballast circuit. Use of the circuit according to the invention will make savings on hardware and energy requirements.

1. A gas discharge lamp driver circuit, comprising an alternating voltage (AC) power source, which has AC output terminals (18), a ballast (20), which is connected to said AC output terminals, a plurality of lamp circuits (30), which are each, in parallel to each other, connected to the ballast, each lamp circuit comprising a gas discharge lamp (32) in series with a current control circuit (34) having a semiconductor switch element, and a selection circuit (36), which is connected to control inputs of the current control circuits to provide an individual selection signal (S1, S2) to each current control circuit to therewith control an amplitude of a current through a lamp which is connected to said latter current control circuit, characterized in that, the AC power source comprises an inverter (10) of a bridge type, of which power input terminals are connected to direct current (DC) power voltage lines (6, 8) for receiving a DC voltage power voltage, the inverter generates the AC power voltage from the DC power voltage with respect to both DC voltage power lines, and the semiconductor switch element is a high frequency unidirectional switch element, which is connected in series with the lamp and to a first DC power line (8) of a first conductivity type.

2. Gas discharge lamp driver circuit according to claim 1, characterized in that, the semiconductor switch element is a field effect transistor (34).

3. Gas discharge lamp driver circuit according to claim 1, characterized in that, the semiconductor switch element is a bipolar transistor with insulated gate.

4. Gas discharge lamp driver circuit according to claim 1, characterized in that, the semiconductor switch element is a bipolar transistor, and a diode is connected anti-parallel to the collector and emitter of the transistor.

5. Gas discharge lamp driver circuit according to claim 1, characterized in that each lamp circuit (30) further comprises a diode (38), which is connected to a second DC line (6) of a second conductivity type and to a node of the lamp (32) and the transistor (34) of said lamp circuit, such that semiconductor regions of said diode and said transistor which are connected to each other are of different conductivity types.

6. Gas discharge lamp driver circuit according to claim 1, characterized in that, each lamp circuit (30) further comprises a resistor (40), which is connected to a second DC line (6) of a second conductivity type and to a node of the lamp (32) and the transistor (34) of said lamp circuit.

7. Gas discharge lamp driver circuit according to claim 5, characterized in that a zener diode (42) is connected in series with the diode (38) and a resistor, such that regions of the zener diode (42) and the diode (38) which are connected to each other are of identical conductivity types.

8. Gas discharge lamp driver circuit according to claim 7, characterized in that the zener diode (42) is common to two or more lamp circuits 30.

9. LCD device of the scanning type, equipped with a backlight comprising a plurality of gas discharge lamps coupled to a gas discharge lamp driver circuit according to claim 1.
